(19) United States
(12) Patent Application Publication
(10) Pub. No.: US 2002/0069956 A1
(43) Pub. Date: Jun. 13, 2002

(54) Overlaminate patch having improved security

(76) Inventor: Bradley A. Paulson, Northfield, MN (US)

Correspondence Address: WESTMAN, CHAMPLIN & KELLY, INTERNATIONAL CENTRE, SUITE 1600, 900 SECOND AVENUE SOUTH, MINNEAPOLIS, MN, 55402-3319, US

(21) Appl. No.: 09/970,447

(22) Filed: Oct. 3, 2001

Related U.S. Application Data
(60) Provisional application No. 60/237,669, filed on Oct. 3, 2000.

(51) Int. Cl. B32B 31/00

(52) U.S. Cl. 156/253; 156/268; 156/269

(57) ABSTRACT

An overlaminate for application to identification card substrates includes a plurality of overlaminate patches. Each patch has an end and is sized in accordance with the identification card substrates. A linking portion connects the ends of the overlaminate patches. A security mark is located in a predetermined position on each patch. Also disclosed are methods of manufacturing the above-identified overlaminate.

### CROSS-REFERENCE TO RELATED APPLICATION

This application claims priority to U.S. Provisional Application Serial No. 60/237,669, filed Oct. 3, 2000, and entitled “OVERLAMINATE PATCH HAVING IMPROVED SECURITY.”

### BACKGROUND

The present invention relates to an overlaminate for use in laminating identification cards. More particularly, the present invention relates to an overlaminate having a security marking thereon.

Identification cards are widely used to carry information relating to the card holder. The use of identification cards is becoming more and more widespread and they are used for many purposes, such as driver licenses, identification badges, etc. Overlaminates are commonly applied to identification card substrates, such as plastic cards, to protect the printing or substrate from abrasion, chemical attack from plasticizers such as those found in vinyl wallet windows, and from ultraviolet radiation. Examples of such overlaminates are disclosed in U.S. Pat. Nos. 5,807,461 and 4,617,080, which are incorporated herein by reference.

For many applications, identification cards are used for security purposes to distinguish authorized individuals from non-authorized individuals. Accordingly, it is important that identification cards be easily authenticated and difficult to counterfeit.

Many complex methods, which are expensive to implement, have been developed for improving the protection of identification cards from counterfeiting and tampering while providing an easy means for authenticating the cards. Although these methods are suitable for large budget operations, smaller operations having more limited budgets would find it difficult to justify their expense. As a result, small operations rely upon more simple methods of preventing counterfeiting of their identification cards.

One such method involves placing security markings, such as holograms, over a surface of the identification card. Such security markings are typically formed in patterns and are randomly positioned on the identification card. The resulting identification cards are difficult to counterfeit since the security markings can not be easily copied. A quick check of the authenticity of the identification card can then be made by simply identifying that the security marks are present on the identification card. This application of patterned security markings to an identification card improves protection from counterfeiting and is fairly inexpensive to implement.

Even so, there is a continuing need for improved counterfeit protection of identification cards that is easy to implement and cost-effective for low budget operations.

### SUMMARY

The present invention relates to an overlaminate for application to identification card substrates. The overlaminate includes a series of overlaminate patches each having an end and sized in accordance with the identification card substrate to which they are to be applied. A linking portion connects the ends of adjacent overlaminate patches together thereby forming a series of linked overlaminate patches. At least one security mark is located in a predetermined position on each patch. The authenticity of the resulting identification card to which an overlaminate patch of the present invention is applied can be checked by verifying not only the existence of the security mark, but also the location of the security mark on the card.

Additional aspects of the present invention relate to methods for manufacturing the above-described overlaminate. In accordance with one of the methods, an overlaminate strip is provided on which a series of security marks are formed. Next, a patch cutting device is aligned relative to at least one of the security marks. Finally, a series of linked patches are cut from the overlaminate strip using the patch cutting device such that each patch contains at least one security mark in a predetermined location.

In accordance with another method, an overlaminate strip is provided and cut into a series of overlaminate patches. Next, a security marking device is aligned with the patches. Finally, a security mark is formed on the patches in a predetermined location using the aligning marks.

### BRIEF DESCRIPTION OF THE DRAWINGS

FIG. 1 is top plan view of an overlaminate in accordance with an embodiment of the invention.

FIGS. 2A and 2B are side plan views examples of a die-cut roller and a punch cutter, respectively.

FIG. 3 is a side plan view of a security marking device in accordance with an embodiment of the invention.

FIG. 4 is a top plan view of a shim of a security marking device illustrating a repeat length of security marking elements.

FIG. 5 is a flowchart illustrating a method of forming an overlaminate strip in accordance with an embodiment of the invention.

FIG. 6 is a top plan view of an overlaminate strip having security marks and aligning marks formed thereon, in accordance with an embodiment of the invention.

FIG. 7 is a flowchart illustrating a method of manufacturing an overlaminate strip in accordance with an embodiment of the invention.

FIG. 8 is a top plan view of a series of a link of patches having an aligning mark formed thereon in accordance with an embodiment of the invention.

### DETAILED DESCRIPTION

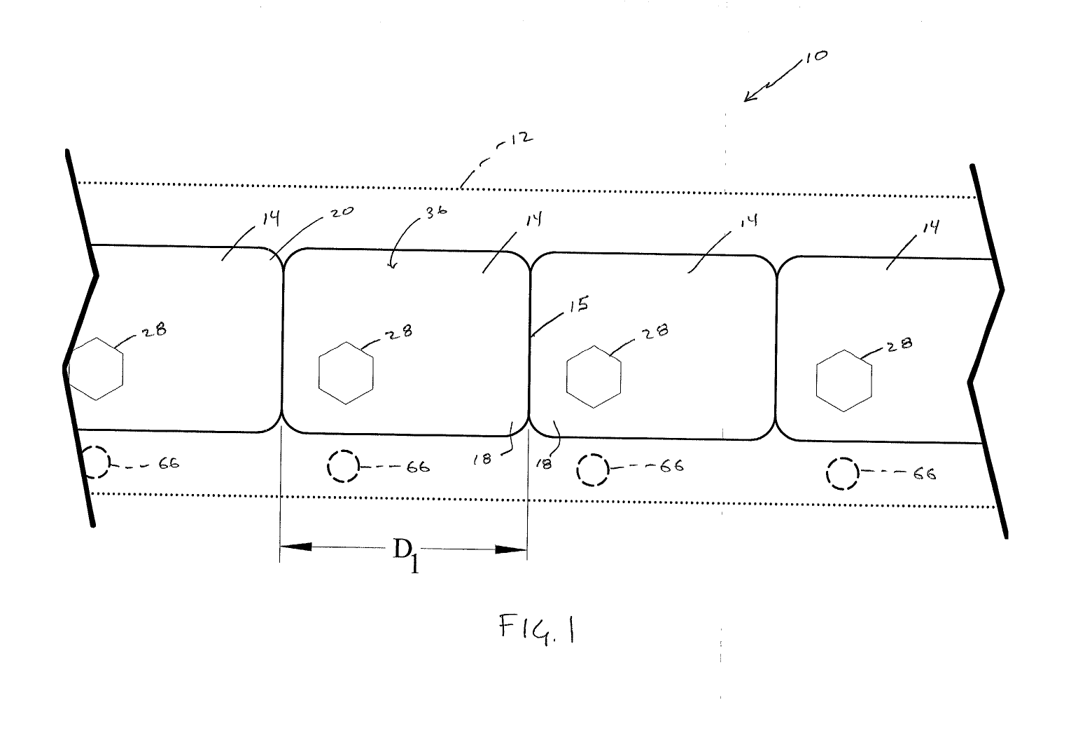

FIG. 1 is a top plan view of an overlaminate, generally designated as 10, in accordance with one embodiment of the invention. Overlaminate 10 is cut from a continuous web or strip of laminate 12, depicted by the dashed lines in FIG. 1. Overlaminate 10 includes a series of laminate patches 14, each of which can be sized in accordance with the substrate that is to be laminated.

Web 12 is generally provided on a supply spool (not shown) and is typically a transparent material that can be laminated onto a suitable substrate, such as a card. Web 12 is preferably a polyester film with a thermal transfer adhesive on one surface, which is used to attach the laminate material to the substrate. A removable backing layer (not shown) could be attached to the adhesive side of web 12 to prevent the contamination of the adhesive and allow for easier handling of web 12.

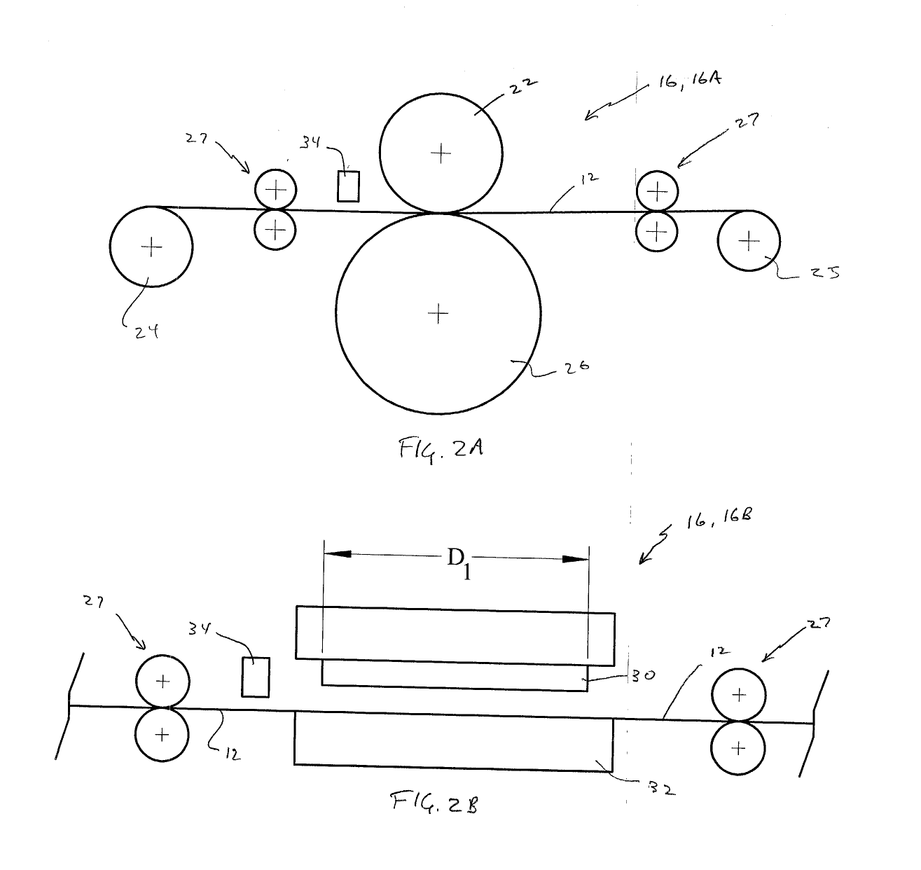

Overlaminate 10 can be cut from web 12 using a patch cutting device 16. Examples of suitable patch cutters 16 include, a die-cut roller 16A or a punch cutter 16B, which are respectively shown in FIGS. 2A and 2B. Other types of conventional patch cutting devices can also be used. Web 12 is generally fed from a supply roll 24 through the patch cutter to a take-up roll 25 with the assistance of guide rollers 27, as shown in FIG. 2A. Patch cutter 16 is adapted to trim the sides of web 12 with a patch cutting component 100 (FIG. 2B) while maintaining a link between each patch 14 at a linking portion 15 as shown in FIG. 1. Linking portion 15 forms a weakened connection between adjoining ends 18 of individual patches 14 to form a series of linked patches 14. The linking portion 15 preferably weakens the tear strength between the ends 18 of adjoining patches 14 by, for example, including suitable perforations to allow the patches 14 to be conveniently separated. In addition, corners 20 of the individual patches 14 can be rounded to conform to the shape of the substrate onto which they are to be applied. Patch cutter 16 has a repeat length D₁ defined as the length between a start of one patch 14 to the start of an adjacent patch 14, as shown in FIG. 1. Preferably, repeat length D₁ is the length of a single patch 14, however, it may be longer in the event that individual patches 14 are separated slightly.

Patch cutter 16A generally includes conventional patch cutting components or dies (not shown) mounted to a roller 22. The patch cutting components on cutting roller 22 trim web 12 to form the linked patches 14 of overlaminate 10 as web 12 is fed through patch cutter 16A. Patch cutter 16B includes at least one patch cutting component 30 that is actuatable to punch-cut individual patches from web 12 by engaging cutting base 32. As web 12 is fed through patch cutter 16B, patch cutting component 30 is repeatedly actuated to form the linked patches 14.

As will be discussed in greater detail below, one embodiment of patch cutter 16 includes a sensor 34 that is used to align the patch cutting component 30 relative to another mark or reference point on web 12. Sensor 34 can be a conventional optical or mechanical sensor depending on the type of aligning mark that is used.

Each patch 14 of overlaminate 10 also includes at least one security mark 28, shown in FIG. 1, that is formed on a surface 36 using a suitable security marking device. When a patch 14 is applied to a identification card substrate, it simplifies the process of authenticating the identification card and provides more protection from counterfeiting since security mark 28 is preferably difficult to copy. Additionally, security mark 28 is positioned on each patch 14 in approximately the same location to provide an additional authentication check and increase protection from counterfeiting. As a result, identification card substrates laminated with a patch 14 will have more security from counterfeiting than identification cards having only randomly located security marks. In accordance with one embodiment of the invention, security mark 28 is combined with a pattern of randomly located security marks to hide the presence of security mark 28.

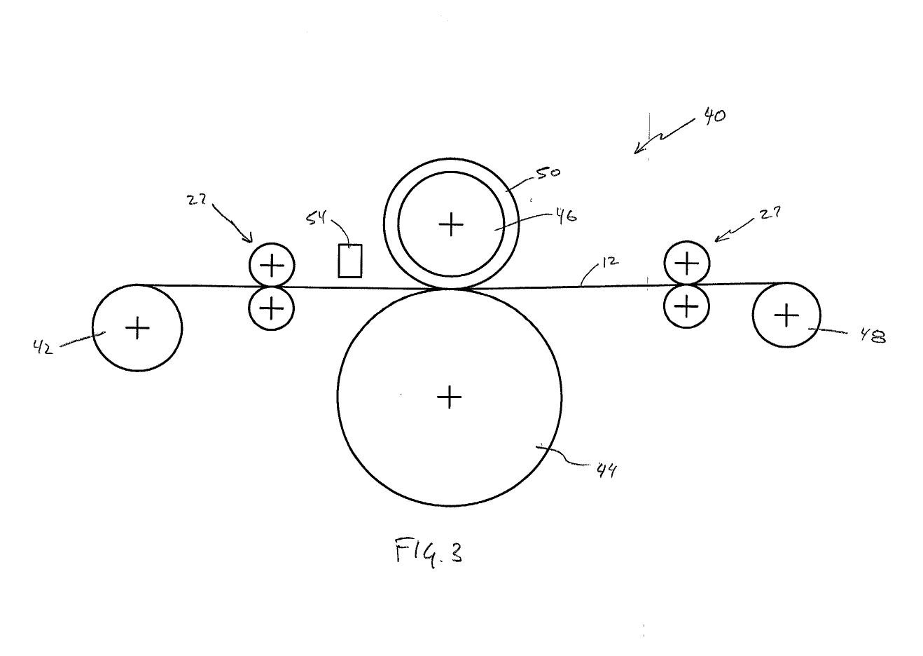

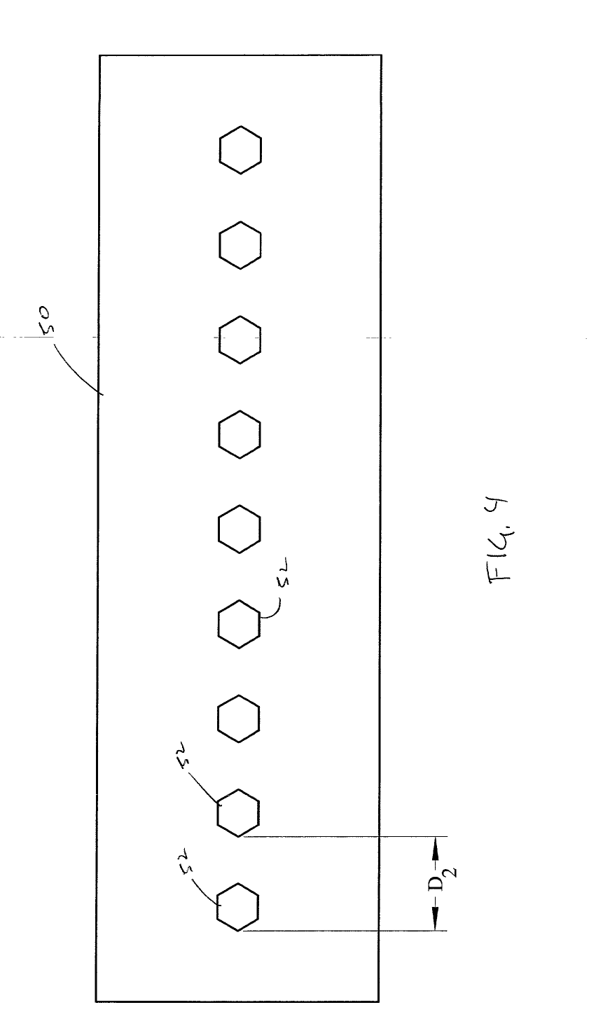

Security mark 28 is a conventional security mark that can be visible to the naked eye, become visible through the use of a viewing tool, or be detectible only by specialized detection equipment. The security marking device typically includes security marking elements to form the security mark 28 on overlaminate 10. In one embodiment of the invention, security mark 28 is a hologram that is formed on each patch 14 using security marking device 40 in the form of a hologram embossing roller, shown in FIG. 3. Hologram embossing roller 40 is typically fed a supply of overlaminate web 12, or a series of linked patches formed by patch cutter 16 as described above, from a supply roller 42. Web 12 is fed between pinch roller 44 and main roller 46 of hologram embossing roller 40 and is collected by a take up roll 48. Main roller 46 includes a shim 50, which is wrapped around the circumference of main roller 46. Shim 50, best shown in FIG. 4, includes security marking elements 52 which, for this example, are hologram embossing elements that are adapted to emboss one or more security marks 28 in the form of holograms on web 12 when web 12 is sandwiched between pinch roller 44 and shim 50.

Similar to patch cutter 16, the security marking device 40 has a repeat length D₂ that is defined as the length between a start of one security marking element 52 to the start of an adjacent security marking element 52, as shown in FIG. 4. Additionally, the security marking device can include a sensor 54 (FIG. 3) that is used to align the security marking elements 52 of the security marking device 40 relative to another mark or reference point on web 12. Sensor 54 can be a conventional optical or mechanical sensor depending on the type of reference that is to be sensed.

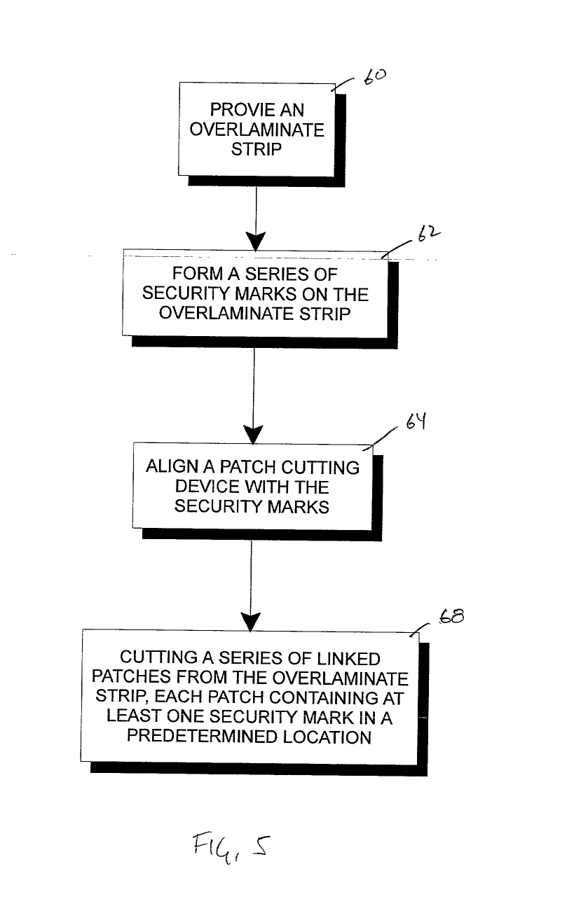

The present invention also relates to methods of manufacturing the above-described overlaminate 10. In accordance with one embodiment of the invention illustrated in the flowchart of FIG. 5, an overlaminate strip or web 12 is provided, at step 60. At step 62, a series of security marks 28 are then formed on the overlaminate strip using a security marking device 40, such as hologram embossing roller. At step 64, a patch cutter 16 is aligned with the security marks 28 such that each patch 14 will contain a security mark 28 in a predetermined location when patches 14 are cut.

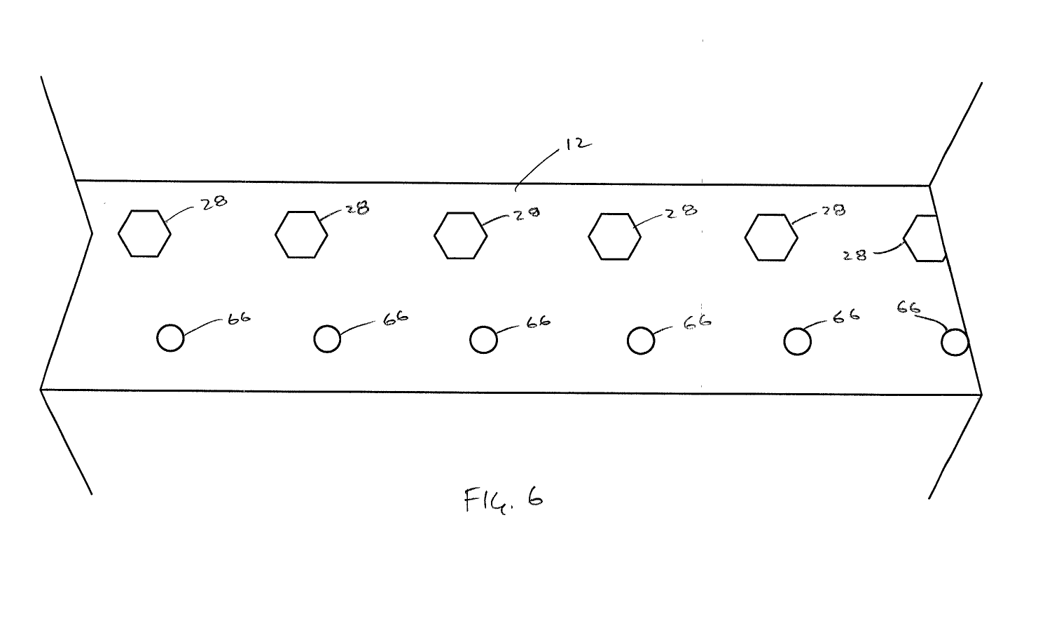

In accordance with one embodiment of the invention, the patch cutter 16 is aligned by matching the repeat length D₁ of the patch cutter with the repeat length D₂ of the security marking device such that the security marks 28 are formed in approximately the same location within each patch 14. In accordance with another embodiment of the invention, aligning marks 66 are formed on the overlaminate strip 12 in a predetermined location relative to at least one of the security marks 28, as shown in FIG. 6. The aligning marks 40 can be a visible mark (e.g., crosshairs, a dot, etc.) or a physical mark (e.g., a notch) formed in accordance with conventional marking methods. Sensor 34 (FIGS. 2A and 2B) of patch cutter 16, is adapted to sense aligning marks 66 and can be used to align patch cutting components 300 with the security marks 28 to ensure that the security marks are formed in a predetermined location within each patch 14 when cut.

Finally, at step 68 of the method, a series of linked patches 14 are cut using the patch cutting device. This produces an overlaminate 10 having a series of linked patches 14, each of which includes at least one security mark 28 positioned in a predetermined location.

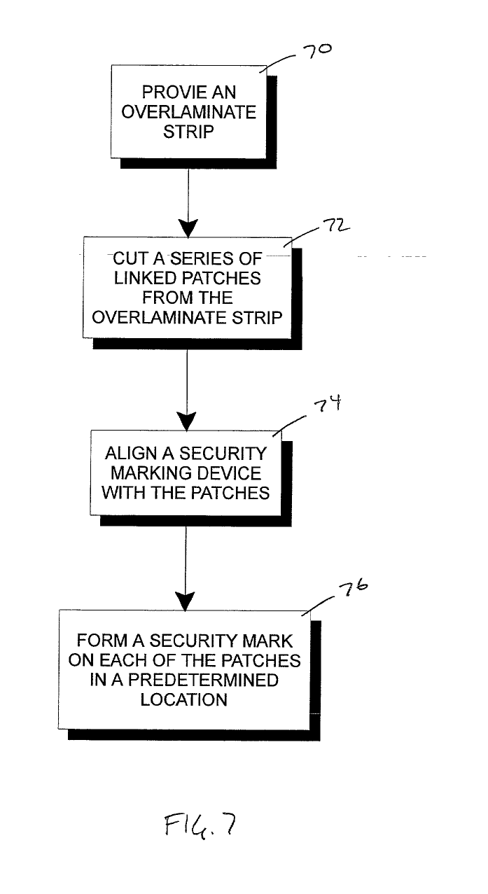

FIG. 7 is a flowchart illustrating another method of manufacturing overlaminate strip 10 in accordance with the present invention. At step 70, an overlaminate strip 12 is provided. At step 72, a series of linked overlaminate patches 14 are provided. At step 74, a security marking device 40, such as a hologram embossing roller, is aligned with the patches 14 such that the security marking elements 52 are positioned to form security marks 28 in a predetermined location on each patch 14.

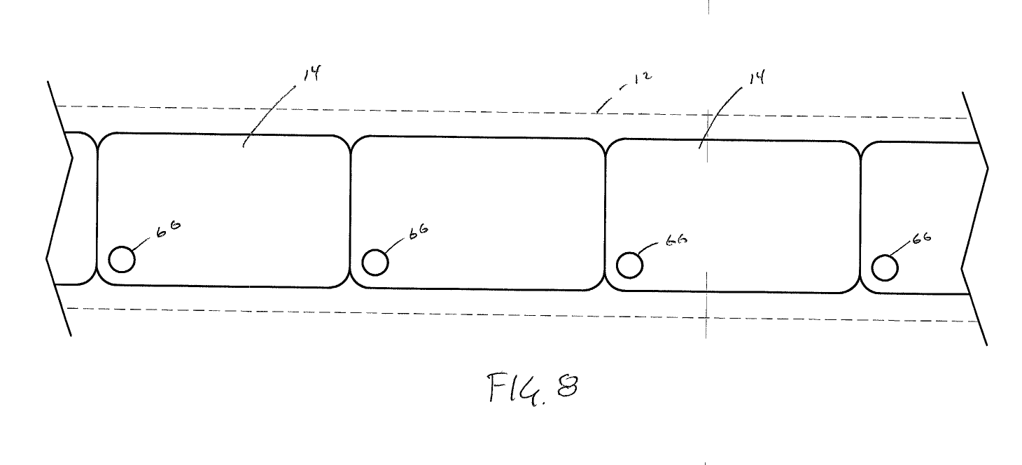

In accordance with one embodiment of the invention, the security marking device 40 is aligned by matching the repeat length D₂ of the security marking device with the repeat length D₁ of the patch cutter such that the security marks 28 are formed in approximately the same predetermined location within each patch 14. In accordance with another embodiment of the invention, aligning marks 66 are formed on either the patches 14, as shown in FIG. 8, or on a backing material beyond the edges of patches 14, as indicated in FIG. 1. The aligning marks 66 are formed in a predetermined location relative to a corresponding patch 14. As mentioned above, the aligning marks 66 can be a visible mark (e.g., crosshairs, a dot, etc.) or a physical mark (e.g., a notch) formed in accordance with conventional marking methods. Sensor 54 (FIG. 4) of security marking device 40, is adapted to sense aligning marks 66 and can be used to align security marking elements 52 with the patches 14 to ensure that the security marks 28 are formed in a predetermined location within each patch 14 when applied.

Finally, at step 76 of the method, at least one security mark 28 is formed on each of the patches 14 in a predetermined location. This produces an overlaminate 10 having a series of link patches 14, each of which includes at least one security mark 28 positioned in a predetermined location.

To ensure that the aligning marks 66 are accurately positioned relative to patches 14 or security marks 28, they are preferably generated at the same time the patches 14 are cut or the security marks 28 are formed.

Although the present invention has been described with reference to preferred embodiments, workers skilled in the art will recognize that changes may be made in form and detail without departing from the spirit and scope of the invention. For example, the patch cutter and security marking device could be combined to eliminate the need to match repeat lengths or use aligning marks by mounting the security marking elements to each patch cutting component. In this manner, each patch cut with the dies will have a security mark in the same location.

What is claimed is:

1. An overlaminate for application to identification card substrates comprising:
a plurality of overlaminate patches, each having an end and sized in accordance with the identification card substrates;
a linking portion connecting the ends of the overlaminate patches; and
at least one security mark located in a predetermined position on each patch.

2. The overlaminate of claim 1 including an aligning mark on each overlaminate patch for alignment of the patch to a card substrate.

3. The overlaminate of claim 1, wherein the security marking is a hologram.

4. The overlaminate of claim 1, wherein the overlaminate includes an bonding layer to bond the overlaminate patches to a card substrate.

5. An identification card including:
a card substrate having a surface; and
one of the overlaminate patches of claim 1 aligned with the card substrate and adhered to the surface.

6. A method of manufacturing an overlaminate for application to identification card substrates comprising steps of:
(a) providing an overlaminate strip;
(b) forming a series of security marks on the overlaminate strip;
(c) aligning a patch cutting device relative to at least one of the security marks; and
(d) cutting a series of linked patches from the overlaminate strip using the patch cutting device such that each patch contains at least one security mark in a predetermined location.

7. The method of claim 6, wherein the aligning step (c) includes matching a security mark repeat length of a security marking device used to form the security marks to a patch cutter repeat length of the patch cutting device.

8. The method of claim 6, wherein the aligning step (c) includes:
forming aligning marks in a predetermined location relative to the security marks; and
aligning the patch cutting device to the security marks using the aligning marks.

9. The method of claim 8, wherein the aligning marks are formed on a portion of the overlaminate strip that is located outside of the patches.

10. The method of claim 8, wherein the aligning marks are formed on a portion of the overlaminate strip that is located within the patches.

11. The method of claim 6, wherein the linked patches are joined at a perforated edge.

12. A method of manufacturing an identification card comprising:
(a) providing a card substrate having a surface;
(b) forming at least one overlaminate patch in accordance with the method of claim 6;
(c) aligning the patch to the card substrate; and
(d) adhering the aligned patch to the surface of the card substrate.

13. A method of manufacturing an overlaminate for application to identification card substrates comprising steps of:
(a) providing an overlaminate strip;
(b) cutting a series of linked patches from the overlaminate strip;
(c) aligning a security marking device to at least one of the patches; and
(d) forming a security mark in a predetermined location on each of the patches using the security marking device.

14. The method of claim 13, wherein the aligning step (c) includes matching a security mark repeat length of the security marking device to a patch cutter repeat length of a patch cutting device used to cut the series of linked patches.

15. The method of claim 13, wherein the aligning step (c) includes:
forming aligning marks in a predetermined location relative to the patches; and
aligning the security marking device to the patches using the aligning marks.

16. The method of claim 15, wherein the aligning marks are formed on the patches.

17. The method of claim 15, wherein the aligning marks are formed on a portion of the overlaminate strip that is located outside of the patches.

18. A method of manufacturing an identification card comprising:
(a) providing a card substrate having a surface;
(b) forming an overlaminate patch in accordance with the method of claim 13;
(c) aligning the patch to the card substrate; and
(d) adhering the aligned patch to the surface of the card substrate.
